(19) United States
(12) Patent Application Publication
(10) Pub. No.: US 2005/0243211 A1
(43) Pub. Date: Nov. 3, 2005

(54) Broadcast receiving apparatus to display a digital caption and an OSD in the same text style and method thereof

(76) Inventor: Joon-hwan Kim, Seoul (KR)

Correspondence Address: STANZIONE & KIM, LLP, 919 18TH STREET, N.W., SUITE 440, WASHINGTON, DC, 20006, US

(21) Appl. No.: 11/086,421

(22) Filed: Mar. 23, 2005

(30) Foreign Application Priority Data
Apr. 30, 2004 (KR) 2004-30717

(51) Int. Cl. H04N 5/50

(52) U.S. Cl. 348/569; 348/564

(57) ABSTRACT

A broadcast receiving apparatus to display a digital caption and an OSD in the same text style and a method thereof. The method includes designating a first designated text style of first text information, storing the first designated text style, creating the first text information to match the first designated text style, selectively creating second text information in the same style as the first designated text style, and displaying the first and second text information. If a user designates the style of either digital caption text or OSD text, the digital caption text and the OSD text are displayed according to the designated style. Accordingly, consistency is kept between the digital caption text and the OSD text to achieve an effect of an improved appearance.

### CROSS-REFERENCE TO RELATED APPLICATIONS

This application claims benefit under 35 U.S.C. § 119 from Korean Patent Application No. 2004-30717, filed on Apr. 30, 2004, in the Korean Intellectual Property Office, the disclosure of which is incorporated herein in its entirety and by reference.

### BACKGROUND OF THE INVENTION

1. Field of the Invention

The present general inventive concept relates to a broadcast receiving apparatus and a method of displaying text information, and more particularly, to a broadcast receiving apparatus to display a digital caption and an OSD (On-Screen Display) in the same text style and a method thereof.

2. Description of the Related Art

A broadcast receiving apparatus is an apparatus that selects a broadcast signal transmitted from a broadcasting station, demodulates the selected broadcast signal, and displays the selected broadcast signal on a display screen. The broadcast receiving apparatus may be embodied as a television receiver (TV), a set-top box, and so on. Hereinafter, the TV will be explained as an example of the broadcast receiving apparatus.

On a TV screen, a digital closed caption (hereinafter, referred to as “digital caption”) and an On-Screen Display (OSD) may be displayed in addition to received broadcast programs.

The digital caption includes text information displaying words of characters and background sound in the broadcast program, on the TV screen as a caption. Through this digital caption displayed on the TV screen, a hearing-impaired person can view the TV. Also, if the digital caption is displayed in a foreign language, it can be used in studying the foreign language.

FIG. 1A is a schematic representation of a TV screen on which a digital caption is displayed. As shown in FIG. 1A, words of characters are displayed on the TV screen as a digital caption 10, and thus a user can visually understand the contents of a conversation between the characters.

An OSD includes text information that is provided from the TV itself to the user. Through the OSD, the user can obtain the operation environment of the TV and other useful information. In addition, the OSD may serve as a user interface.

FIG. 1B shows examples of OSDs that can be provided by the TV. Referring to FIG. 1B, the user can recognize a selected channel and a present time through a channel OSD 21 and a present-time OSD 23, respectively, and can adjust a volume through a volume OSD 25.

Recently, user's taste and preference have been considered in displaying digital captions. That is, a style of the text being displayed as the digital caption (hereinafter referred to as “digital caption text”) can be selected to meet the user's taste.

In the United States, a Federal Communication Commission (FCC) rule prescribes that digital TV products make it possible to change the digital caption text according to a user's taste. Also, the FCC requires the size, font, foreground color and background color of the digital caption text be changeable.

As described above, the style of the digital caption text may be changed according to the user's taste. However, if the style of the digital caption text is changed, it would not coincide with the style of the text that is displayed as the OSD (hereinafter referred to as “OSD text”). If the style of the digital caption text becomes different from the style of the OSD text, the texts displayed on the TV screen become inconsistent in their styles, and this may cause an undesirable appearance.

In this case, the user must separately designate the style of the OSD so as to make the style of the OSD equal to the style of the digital caption text. Further, if the TV does not provide an option to change the OSD text style, even this separate designation of the OSD text style becomes impossible.

### SUMMARY OF THE INVENTION

The present general inventive concept provides a broadcast receiving apparatus to display a digital caption and an OSD (On-Screen Display) in the same text style and a method to display the digital caption text and the OSD text in the same style designated by a user.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a method of displaying text information, the method including designating a designated text style of first text information, storing the designated text style, creating the first text information according to the designated text style, creating second text information according to the designated text style, and generating the created first and second text information.

The first text information may be created based on a first text signal received from an external source. Also, the first text information may include a digital caption.

The second text information may be created based on a second text signal pre-stored in a broadcast receiving apparatus. Also, the second text information may include at least one among an on-screen display (OSD), a menu and broadcast program information.

The text style may include at least one of a text size, a font, a foreground color and a background color.

The designated text style may further include a first text style and a second text style, and the creating of the first text information and the second text information may include receiving either an equal display command or a separate display command regarding text styles of the first and second text information, creating and displaying the first and second text information according to one of the first and second text styles upon receiving the equal display command, and creating and displaying the first and second text information according to the first and second text styles upon receiving the separate display command.

A plurality of text styles may be designated and stored, and the first and second text information may be created according to one of the plurality of text styles.

The foregoing and/or other aspects and advantages of the present general inventive concept may also be achieved by providing a broadcast receiving apparatus which includes a storage unit to store a designated text style of first text information, a text creating unit to create the first text information and second text information, a control unit to control the text creating unit so that the first and second text information are created according to the designated text style stored in the storage unit, and a display unit to display the first and second text information created by the text creating unit.

The text creating unit may create the first text information using a first text signal received from an external source and may create the second text information using a text pre-stored in the broadcast receiving apparatus.

The first text information may be a digital caption, and the second text information may include at least one of an on-screen display (OSD), a menu and broadcast program information.

The text style may include at least one of a text size, a font, a foreground color and a background color.

The designated text style may include a first text style and a second text style, and the control unit may control the text creating unit so that the first and second text information are created according to one of the first and second text styles if an equal display command regarding the text style of the first and second text information is input, and may control the text creating unit so that the first and second text information are created according to first and second text styles if a separate display command regarding the text style of the first and second text information is input.

The storage unit may store a plurality of text styles, and the control unit may control the text creating unit so that the first and second text information are created according to the selected one of the plurality of text styles stored in the storage unit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1A is a schematic representation of a conventional TV screen on which a digital caption is displayed;

FIG. 1B is a schematic representation of a conventional TV screen on which an OSD is displayed;

FIG. 2 is a block diagram illustrating a broadcast receiving apparatus to display a digital caption and an OSD in the same text style, according to an embodiment of the present general inventive concept;

FIG. 3 is a flowchart illustrating a method to display a digital caption and an OSD in the same text style, according to an embodiment of the present general inventive concept;

FIG. 4 is a schematic representation of a displayed menu to designate a style of a digital caption text according to an embodiment of the present general inventive concept; and

FIG. 5 is a schematic representation of a displayed menu to designate a style of an OSD text according to an embodiment of the present general inventive concept.

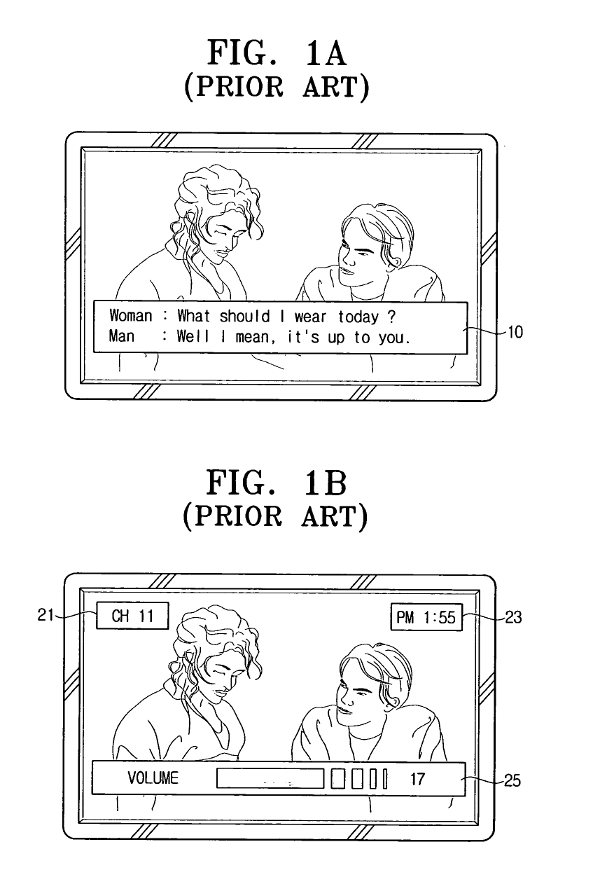

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The matters defined in the description such as a detailed construction and elements are nothing but the ones provided to assist in a comprehensive understanding of the general inventive concept. Thus, it is apparent that the present general inventive concept can be carried out without those defined matters. Also, well-known functions or constructions are not described in detail since they would obscure the general inventive concept in unnecessary detail.

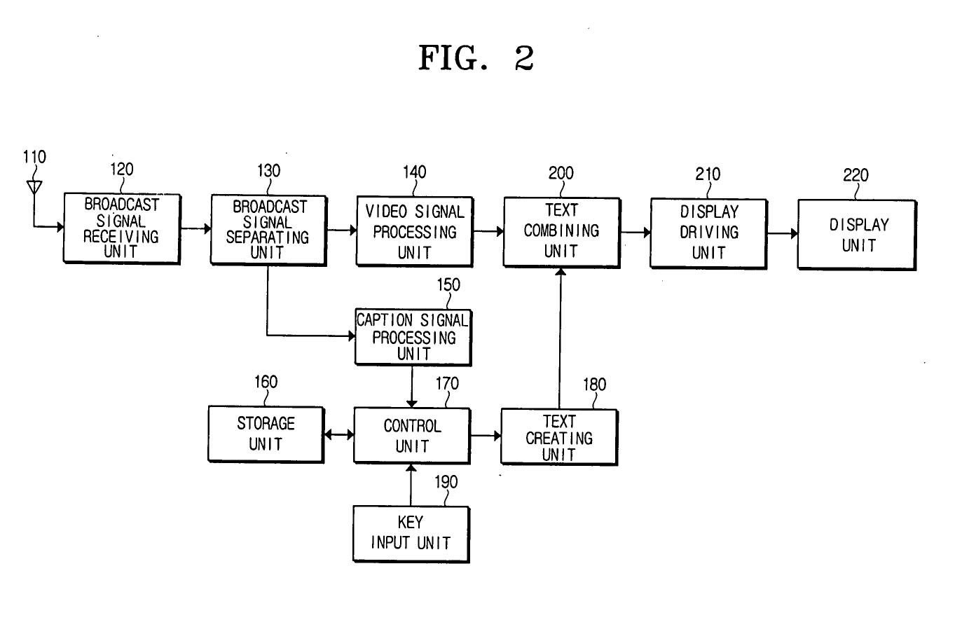

FIG. 2 is a block diagram illustrating a broadcast receiving apparatus to display a digital caption and an OSD, which is an example of text information, in the same text style according to an embodiment of the present general inventive concept. Referring to FIG. 2, the broadcast receiving apparatus includes an antenna 110, a broadcast signal receiving unit 120, a broadcast signal separating unit 130, a video signal processing unit 140, a caption signal processing unit 150, a storage unit 160, a control unit 170, a text creating unit 180, a key input unit 190, a text combining unit 200, a display driving unit 210 and a display unit 220.

The broadcast signal receiving unit 120 selects and demodulates a broadcast channel selected among digital broadcast signals inputted through the antenna 110 by a user input through the key input unit 190. The broadcast signal could alternatively be received in a different manner. The broadcast signal separating unit 130 separates the demodulated digital broadcast signal into a digital audio signal, a digital video signal and a digital caption signal, and transfers the separated digital video signal and digital caption signal to the video signal processing unit 140 and the caption signal processing unit 150, respectively.

The video signal processing unit 140 processes and converts the transferred digital video signal into a video signal that can be displayed on a display screen. The caption signal processing unit 150 decodes the transferred digital caption signal into a digital caption text array and outputs the decoded caption text array to the control unit 170.

The storage unit 160 is a recording medium in which programs required to drive the broadcast receiving apparatus and data are stored. Particularly, the storage unit 160 stores information about digital caption text styles designated by the user.

The control unit 170 controls operations of the broadcast receiving apparatus according to a user's command. Particularly, the control unit 170 creates a digital caption text signal based on the digital caption text array transferred from the caption signal processing unit 150 and information about the digital caption text style read out from the storage unit 160, and provides the created digital caption text signal to the text creating unit 180. Accordingly, the created digital caption text signal includes information about a digital caption text and its style.

Also, if the control unit 170 decides that an OSD display is required as a result of receiving the user's command through the key input unit 190, it creates and provides an OSD text signal to the text creating unit 180. The OSD text signal includes information about an OSD text and its style.

In creating the OSD text signal, the control unit 170 considers the information about the digital caption text style stored in the storage unit 160. This is to make the style of the OSD text equal to the style of the digital caption text.

The text creating unit 180 creates the digital caption text and the OSD text that correspond to the digital caption text signal and the OSD text signal, respectively, received from the control unit 170.

The key input unit 190 is a user interface device that receives user's manipulation commands, including the user's command and the user input. The key input unit 190 is generally provided on a front part of the broadcast receiving apparatus. The key input unit 190 may also be implemented using a remote controller and a light receiving unit to receive a remote signal from the remote controller, or any other suitable input device.

The text combining unit 200 combines the digital caption text and the OSD text created from the text creating unit 180 with the video signal outputted from the video signal processing unit 140.

The display driving unit 210 drives the display unit 220 to display an image corresponding to an output signal of the text combining unit 200.

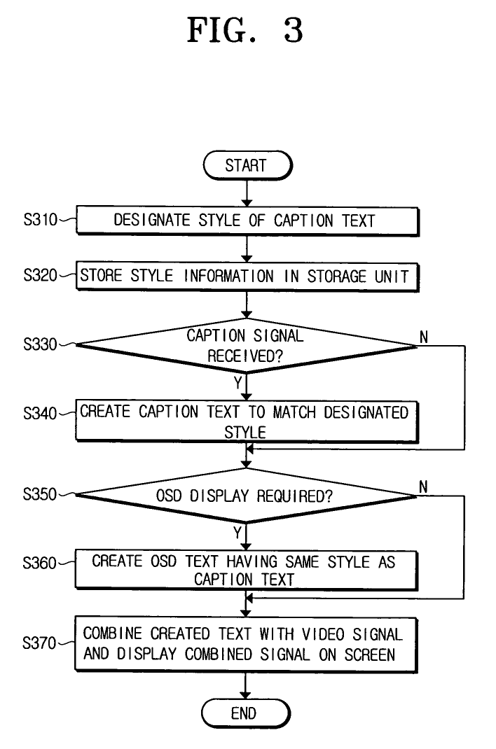

Hereinafter, the process to display a digital caption text and an OSD text through the broadcast receiving apparatus of FIG. 2 will be explained in detail with reference to FIG. 3. FIG. 3 is a flowchart illustrating a method to display a digital caption and an OSD in the same text style according to an embodiment of the present general inventive concept.

First, if the user designates the style of the digital caption text through a menu displayed on the screen (operation S310), the control unit 160 makes the storage unit 160 store information about the designated digital caption text style (operation S320).

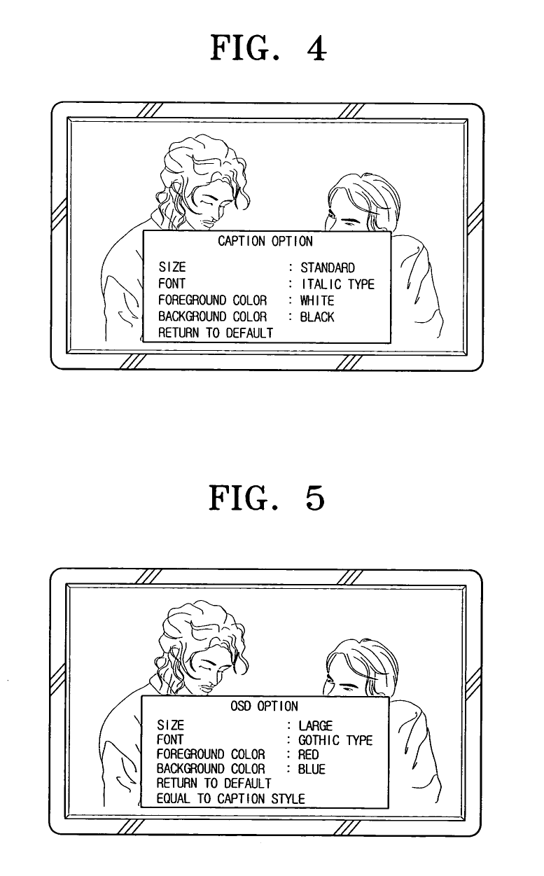

The menu used to designate the style of the digital caption text is illustrated in FIG. 4. Through this menu, the user can designate a size, font, foreground color and background color of the digital caption text. Specifically, the size that can be selected by the user includes “Small,” “Standard” and “Large,” and the font includes “Italic type,” “Gothic type,” and so forth. The foreground color and the background color include “White,” “Black,” “Red,” “Green,” “Blue,” and so forth.

Then, if the digital caption signal is received (operation S330), the broadcast receiving apparatus creates the digital caption text to match the style designated in operation S310 (operation S340).

The digital caption signal, which is included in the digital broadcast signal, is received through the broadcast signal receiving unit 120 at the same time as the digital broadcast signal. The digital caption signal is separated from the digital broadcast signal through the broadcast signal separating unit 130, and decoded to the digital caption text array through the digital caption signal processing unit 150. The decoded digital caption text array is transferred to the control unit 170.

The control unit 170 creates the digital caption text signal based on the transferred digital caption text array and the information about the digital caption text style readout from the storage unit 160. Accordingly, the digital caption text signal includes information about the digital caption text and its style. The created digital caption text signal is applied to the text creating unit 180.

The text creating unit 180 creates the digital caption text corresponding to the applied digital caption text signal. For this, the text creating unit 180 reads out the text having the corresponding font among the texts stored in the text creating unit 180, and adjusts the size, foreground color and background color of the readout text. The digital caption text created through the above process is applied to the text combining unit 200.

If an OSD display is required (operation S350), the broadcast receiving apparatus creates the OSD text having the same style as the digital caption text designated in operation S310 (operation S360).

The OSD display is required mostly when responding to the user's manipulation of the key input unit 190. For example, in the case of a manipulation causing a channel change, it is required that a changed channel number is displayed by an OSD, and in the case of a manipulation causing a present-time display request, it is required that a present time is displayed by an OSD. In addition, the OSD display is required even when providing a user interface such as a volume control or in the case of providing a warning message.

The control unit 170 creates the OSD text signal that includes information about the OSD text to be displayed and its style, and provides the created OSD text signal to the text creating unit 180. In this case, the control unit 170 sets the style of the OSD text to the same style as the digital caption style stored in the storage unit 160.

Accordingly, the OSD text created through the text creating unit 180 based on the OSD text signal has the same style as the digital caption text. The created OSD text is provided to the text combining unit 200.

The texts created in operations S340 and S360 are combined with the video signal to be displayed on the display screen (operation S370).

For this, the text combining unit 200 combines the digital caption text and the OSD text created from the text creating unit 180 with the video signal outputted from the video signal processing unit 140. The display driving unit 210 operates the display unit 220 to display an image corresponding to an output signal of the text combining unit 200.

As described above, in the embodiment of the present general inventive concept, if the user designates the style of the digital caption text, not only the digital caption text but also the OSD text are displayed according to the designated style of the digital caption text.

Hereinafter, in another embodiment of the present general inventive concept, it is possible to select whether to display the OSD text with the same style as the digital caption text. According to this embodiment of the present general inventive concept, the style of the OSD text can be set to be equal to the style of the digital caption text or to be different from the style of the digital caption text.

For this, a menu provided on the display screen to designate the style of the OSD text as illustrated in FIG. 5 is used. If the user designates the style, such as the size, the font, the foreground color and the background color, of the OSD text through the menu displayed on the screen, the control unit 170 operates the storage unit 160 to store the information about the designated style of the OSD text.

Then, the storage unit 160 also stores the style of the OSD text in addition to the information about the style of the digital caption text. Since the control unit 170 refers to the information about the style of the digital caption text to create the digital caption text signal and refers to the information about the style of the OSD text to create the OSD text signal, both styles may be different from each other.

If the user selects a term “Equal to Caption Style” from the menu as shown in FIG. 5, the style of the OSD text becomes equal to the style of the digital caption text. This produces the same result as the case of that embodiment of the present general inventive concept in which the OSD text and the digital caption text are displayed according to the designated style.

Consequently, it is possible to display the OSD text and the digital caption text in the same style or in the different styles in accordance with the user's selection.

If the user designates the style of the digital caption text, the style of the OSD text is automatically designated in the same style as the digital caption text. However, it will be apparent that if the style of the OSD text is designated instead of the digital caption text, the style of the digital caption text is automatically designated in the same style as the OSD text.

In the case of a plurality of users using one broadcast receiving apparatus, it is also possible that respective users can separately designate the style of the digital caption text and the OSD text in consideration of those respective users' tastes. In this case, information about styles designated by the respective users is stored in the storage unit 160. If the user selects and designates a style among the styles stored in the storage unit 160, the digital caption text and the OSD text are displayed according to the designated style.

In the embodiments of the present general inventive concept, the OSD has been exemplified as the text information that is displayed in the same style as the digital caption. However, this is merely exemplary and it will be apparent that the present general inventive concept can be applied in other applications, including text information, such as a TV menu and an EPG (Electronic Program Guide), displayed in addition to the OSD. In other words, the present general inventive concept can be applied to any text information that can be displayed on a broadcast receiving apparatus or a monitor connected to a computer.

Also, in the embodiments of the present general inventive concept, the text size, font, foreground color and background color have been described as the text style. However, this is merely exemplary and it will be apparent that the present general inventive concept can also be applied to a letter slope, spacing, width, shade and so on. That is, the range of the text style to which the present general inventive concept is applied has no limitation.

As described above, if the user designates the style of either the digital caption text or the OSD text, the digital caption text and the OSD text are displayed according to the designated style. Accordingly, the consistency is kept between the digital caption text and the OSD text to achieve an effect of a fine view. Also, the user does not have to dedicatedly designate the styles of the digital caption text and the OSD text since the styles of the digital caption text and the OSD text are automatically set to the same if the user designate the style of either of the digital caption text and the OSD text.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of displaying text information, comprising:
designating a designated text style of first text information;
storing the designated text style;
creating the first text information according to the designated text style;
creating second text information according to the designated text style; and
generating the created first and second text information.

2. The method as claimed in claim 1, wherein the first text information is created based on a first text signal received from an external source.

3. The method as claimed in claim 2, wherein the first text information comprises a digital caption.

4. The method as claimed in claim 1, wherein the second text information is created based on a second text signal pre-stored in a broadcast receiving apparatus.

5. The method as claimed in claim 4, wherein the second text information comprises at least one of an on-screen display, a menu, and broadcast program information.

6. The method as claimed in claim 1, wherein the designated text style comprises at least one of a text size, a font, a foreground color, and a background color.

7. The method as claimed in claim 1, wherein the designated text style comprises a first text style and a second text style, and the creating of the first text information and the second text information comprises:
receiving either an equal display command or a separate display command regarding the first and second text styles of the first and second text information;
creating and displaying the first and second text information according to one of the first and second text styles upon receiving the equal display command; and
creating and displaying the first and second text information according to the first and second text styles, respectively, upon receiving the separate display command.

8. The method as claimed in claim 1, wherein the designated text style comprises one selected from a plurality of text styles and the first and second text information are created according to the selected one of the plurality of text styles.

9. The method as claimed in claim 1, wherein the first text information and the second text information are a first OSD and a second OSD, respectively.

10. The method as claimed in claim 1, wherein the first text information comprises a text generated according to an external signal, and the second text information comprises a text generated according to a pre-stored signal.

11. A method to display text information, comprising:
storing at least one designated text style;
creating on-screen display text and digital caption text according to at least one of the designated text styles; and
generating an image comprising the on-screen display text and the digital caption text.

12. The method as claimed in claim 11, wherein the storing of the at least one designated text style comprises:
receiving a user manipulation from a menu screen to select the at least one designated text style.

13. The method as claimed in claim 11, wherein the storing of the at least one designated text style comprises:
generating a menu screen through which the at least one designated text style is input.

14. The method as claimed in claim 13, wherein the menu screen comprises:
an equal display selection; and
a separate display selection.

15. A method to display text information, comprising:
receiving a first text;
receiving a second text; and
selectively applying a designated text style to both the first and second texts.

16. A broadcast receiving apparatus comprising:
a storage unit to store a designated text style of first text information;
a text creating unit to create the first text information and second text information;
a control unit to control the text creating unit so that the first and second text information are created according to the designated text style stored in the storage unit; and
a display unit to display the first and second text information created by the text creating unit.

17. The apparatus as claimed in claim 16, wherein the text creating unit creates the first text information using a first text signal received from an external source and creates the second text information using a text pre-stored in the broadcast receiving apparatus.

18. The apparatus as claimed in claim 17, wherein the first text information comprises a digital caption, and the second text information comprises at least one of an on-screen display, a menu, and broadcast program information.

19. The apparatus as claimed in claim 16, wherein the text style comprises at least one of a text size, a font, a foreground color, and a background color.

20. The apparatus as claimed in claim 16, wherein the designated text style comprises a first text style and a second text style, and the control unit controls the text creating unit so that the first and second text information are created according to one of the first and second text styles if an equal display command regarding the text style of the first and second text information is input, and the control unit controls the text creating unit so that the first and second text information are created according to first and second text styles if a separate display command regarding the text style of the first and second text information is input.

21. The apparatus as claimed in claim 16, wherein the storage unit stores a plurality of text styles, and the control unit controls the text creating unit so that the first and second text information are created according to the selected one of the plurality of text styles stored in the storage unit.

22. A broadcast receiving apparatus comprising:
a storage unit to store at least one designated text style;
a text creating unit to create an on-screen display text and a digital caption text according to the at least one designated text styles; and
a unit to generate an image comprising the digital caption text and the on-screen display text.

23. The apparatus as claimed in claim 22, further comprising:
a key input unit to receive a user manipulation from a menu screen to select the at least one designated text style.

24. The apparatus as claimed in claim 22, wherein the unit to generate an image comprising the digital caption text and the on-screen display text generates a menu screen through which the at least one designated text style is input.

25. The apparatus as claimed in claim 24, wherein the menu screen comprises:
an equal display selection; and
a separate display selection.

26. A broadcast receiving apparatus comprising:
a text creating unit to create a first text and a second text according to a designated text style; and
a unit to generate an image comprising the first text and the second text.
